(19) United States
(12) Patent Application Publication
(10) Pub. No.: US 2004/0033777 A1
(43) Pub. Date: Feb. 19, 2004

(54) Method of self-adaptive management of the pertinence of multimedia contents for use in multimedia content receivers and an associated receiver

(75) Inventors: Jean Farineau, Levallois Perret (FR); Nicolas Chuberre, Tournefeuille (FR)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/448,125

(22) Filed: May 30, 2003

(30) Foreign Application Priority Data
May 31, 2002 (FR) 02 06 709

(51) Int. Cl. H04H 1/00

(52) U.S. Cl. 455/3.02; 705/51; 455/67.11; 455/427; 455/422.1

(57) ABSTRACT

A method of self-adaptive management of the pertinence of multimedia contents for use in a multimedia content receiver in a telecommunication network takes account of a long-term user profile corresponding to a set of permanent interests of the user of the receiver and a short-term user profile corresponding to a set of temporary interests of the user. A receiver implementing the method is also disclosed.

### CROSS-REFERENCE TO RELATED APPLICATIONS

This application is based on French Patent Application No. 02 06 709 filed May 31, 2002, the disclosure of which is hereby incorporated by reference thereto in its entirety, and the priority of which is hereby claimed under 35 U.S.C. §1 19.

### BACKGROUND OF THE INVENTION

1. Field of the Invention

The field of the present invention is that of multimedia content management, and the invention relates more particularly to a method of self-adaptive management of the pertinence of multimedia contents for use in a multimedia content receiver in a telecommunication network.

The invention also relates to the associated multimedia content receiver.

2. Description of the Prior Art

The above kind of receiver can be connected to a radio broadcast network broadcasting news with multimedia content. The system is based on a network of terrestrial transmitters, geosynchronous or non-geosynchronous broadcast satellites, or a combination of broadcast satellites and terrestrial repeaters.

The load on high bit rate broadcast networks is very unevenly distributed throughout the day.

At busy times, i.e. when the network is heavily loaded, the network is saturated and offers only a limited bit rate per user, as a result of which response times are relatively long.

At slack times, i.e. when the network is lightly loaded, especially during the night, from 0 h to 8 h, the network is very seriously underutilized.

These disparities in the use of the network are problematical for users and for the network operator. Users have to devote excessive time to accessing the data they require and pay for a service that frequently does not achieve the required quality in terms of speed and availability during the daytime.

To enhance the quality of service during the daytime, operators install high-capacity network infrastructures that are seriously underutilized at slack times, which implies a significant reduction in cost effectiveness for the operators.

Moreover, a significant proportion of the data of interest to users relates to various aspects of the news, for example financial, economic or sporting news.

This type of news consists of news items that are generally of interest to a large number of users, and network saturation problems arise because the same news is sent several times to different users, generally in the daytime, most often in slack periods.

Smoothing the network load would improve the availability of the network in periods of heavy use without necessitating an increase in its capacity.

This is the subject matter of French patent application No. FR 00 06 691 filed on May 25, 2000.

The invention of the above application relates to a method of broadcasting multimedia news items to a receiver that allows for a standard profile of the receiver user based on the user's interests. However, only one type of user profile is generated, based on interests of the user that could be described as permanent over a given period.

The invention aims to solve the problems identified above.

An object of the invention is therefore to propose a method of managing the pertinence of multimedia content for use in a multimedia content receiver that adapts automatically to the interests of the user, however they may change, avoiding the necessity for an explicit declaration of the interests of the user, a task that is very demanding and even out of the question when the target audience is the general public.

### SUMMARY OF THE INVENTION

To this end, the invention provides a method of self-adaptive management of the pertinence of multimedia contents for use in a multimedia content receiver in a telecommunication network, when each content is classified in accordance with a tree of categories ranging from the general to the specific, which method takes account of a long-term user profile corresponding to a set of permanent interests of the user of the receiver and a short-term user profile corresponding to a set of temporary interests of the user.

Thus, according to the invention, the user is characterized by a set of permanent, latent interests that change little over the year and a set of momentary interests, for example related to his current location, activities, breaking news or recent events; given the two types of interest, the method of the invention aims to make available to the user content that accords with both types. In addition to content management taking account of permanent interests, the mechanism based on the short-term user profile complements the aforesaid management by taking account of changes in the interests of the user.

Furthermore, although the inventive receiver that is the subject matter of the patent application No. FR 00 06 691 mentioned above is ingenious, it establishes “blinkers” that degrade the quality of service provided. This is because, the more advanced the learned user profile, the more accentuated is the effect of rejecting fields that do not correspond to the user's usual concerns.

To solve the above problem, one embodiment of the method according to the invention assigns priority to processing received content identified as having priority.

Thus broadcasting content identified as having priority circumvents the natural barrier set up by filtering mechanisms based on identifying the user profile. In terms of news broadcasts, this essentially relates to content that appears in one of the daily newspapers.

In one embodiment, a generic user profile is previously defined for a user of the receiver and the long-term user profile is deduced from the generic user profile so as to be subject to the same variations as the latter, this trend being determined over a period much longer than that used for the generic user profile.

In one embodiment, each content is classified in accordance with a category tree from the general to the specific by means of a pointer identifying the branch to which the content belongs, each branch being assigned a weight wG_{i.j.k} representing the degree of interest of the user in the branch, the weight variation [symbol] wG_{i.j.k} being defined by the following equation, in which G stands for “generic” and i.j.k designates the branch to which the content is attached:

[symbol]

wG_{i.j.k}=wG_{i.j.k}−wG_{i.j.k}⁻¹,

in which wG_{i.j.k}⁻¹ represents the value of wG_{i.j.k} at the end of the preceding cycle,

and the weight w_{i.j.k} of the branch i.j.k for the long-term user profile is deduced from the weight w_{i.j.k}⁻¹ of that branch in the preceding cycle, using the following formula:

wL_{i.j.k}k=wL_{i.j.k}⁻¹+α· [symbol] wG_{i.j.k}

where α is a constant much less than 1, for establishing a much slower progression of the weight for the long-term user profile and therefore a variation with the same trend for the long-term user profile relative to that of the generic user profile, in accordance with the following equation, in which LTUP is the long-term user profile and GUP is the generic user profile:

LTUP=LTUP⁻¹α· [symbol] GUP.

In one embodiment the short-term user profile STUP is deduced from the generic user profile and the long-term user profile using the following equation, in which pos( )=the value of the argument if the argument is positive, or 0 otherwise:

STUP=pos(GUP−LTUP).

In one embodiment the memory capacity available for the cache memory is divided into three memory parts, respectively a part associated with the long-term user profile, a part associated with the short-term user profile, and a part intended for storing priority contents, and the cache memory part C_{i.j.k} assigned to each branch i.j.k of the tree is deduced, for that part, from the relative weight w_{i.j.k} of the branch, using the following equation, in which Cₜₒₜₐₗ represents the total memory capacity for each part:

C_{i.j.k}=(w_{i.j.k}/Σw_{i.j.k})·Cₜₒₜₐₗ.

In one embodiment a pertinence score is evaluated for each content as a function of an estimated pertinence supplied by the content provider and as a function of the user profile.

In one embodiment the score of each content received is equal to the product of the weight of the branch to which the content belongs and the pertinence of the content.

In one embodiment the pertinence varies within a range of values from 0.1 to 10, where the value for a standard content is 1, marginal news tends toward the lower limit of 0.1, and important news tends toward the value 10.

In one embodiment a description vector of each content is broadcast to the receiver before broadcasting the associated content and includes a content identifier and the duration of the content, and respective tables associated with the long-term user profile, the short-term user profile and the priority content are created and then updated and list in detail, in decreasing order, the associated identifier, score and duration.

It should be emphasized here that the hypothesis adopted is that a received content has a fixed compression ratio so that its duration is proportional to its capacity. Such would not be the case, of course, if the compression ratios differed from one content to another (for example, compressed musical content is broadcast at 64 kbit/s or 128 kbit/s whereas compressed news content is broadcast at 32 kbit/s). In the latter case, the description of FIG. 6 in particular must be modified in that it shows a list of contents that must be selected so that the sum of the capacities necessary for storage in each cache partition does not exceed the capacity reserved for each of the three partitions; the duration concept is normally operative only at the presentation level.

In one embodiment, on receiving each content, the presence of the associated identifier in one of the three tables is verified and a positive result leads to storage of the content in the memory part corresponding to the table in which the presence of the identifier has been detected.

In one embodiment the memory parts respectively associated with the long-term user profile and the short-term user profile are filled in order of decreasing content score until saturation of the respective parts.

In one embodiment selection redundancies between the long-term memory part and the short-term memory part are eliminated by eliminating contents having the lowest score.

One embodiment includes learning the generic user profile on initialization of the receiver on the basis of the typical user profile and from the first contents received and the weight variation applied to the branch to which each of the contents belongs, the variation being a function of input of commands to the received by the user and the time after which the commands are entered.

In the present application, tT denotes the time for which the content is accessed, which can be measured if the content is “streamed” (audio, video) or otherwise (text, web page) evaluated as the average consultation time for an average listener. This concept of the access time tT is used hereinafter.

In one embodiment, a set of temporal reference values is established on the basis of the typical access time tT in order to be able to apply the principle defined above of interpreting the training procedure, the objective of which is to characterize the interests of a user or of a group of users sharing the access equipment. The user group may be a family, a school class, etc.

In one embodiment, the temporal reference values are established in proportion to the typical value tT associated with the content concerned relative to an established value representative of an average duration content, and some values (in particular the value tA defined hereinafter) can be established in an invariant manner, enabling interpretation of aspects of behavior that do not depend on the total content access time for an average user.

In one embodiment, consultation of a given content for a time less than a first value (t_{D}) leads to a negative variation of the weight attached to the branch and consultation for a time greater than the first value leads to a positive variation of the weight thereof.

In one embodiment consultation of the content for a time greater than a second value greater than the first value leads to no modification of the weight of the branch.

In one embodiment at least the first and second values are corrected self-adoptively as a function of the actual behavior of the user during the consultation cycle.

In one embodiment archival storage of a content received by the receiver within a time less than a third value leads to no variation of the weight of the branch to which the content belongs and archival storage of the contents after a time greater than the third value leads to a positive variation of that weight.

In one particular embodiment, the standard user profile is recovered by the receiver from the received data stream, in which case the initialization user profile is broadcast cyclically for use by receivers receiving for the first time the broadcast channel concerned.

The invention also provides a multimedia content receiver in a telecommunication network that uses the method according to the invention.

With the aim of explaining the invention better, embodiments of the invention are described next by way of non-limiting example and with reference to the accompanying drawings.

### BRIEF DESCRIPTION OF THE DRAWINGS

FIG. 1 is a diagram showing a content broadcasting and receiving system in accordance with the invention.

FIG. 2 is a flowchart showing various steps of a method in accordance with the invention of routing content.

FIGS. 3, 4 and 5 represent a tree structure content classification at various stages in the process of learning the user profile.

FIG. 6 shows three tables of content description vectors sorted in decreasing interest level, the tables respectively corresponding to content retained for the long-term user profile, content retained for the short term user profile, and priority content.

FIG. 7 shows a user interface of a receiver according to the invention.

FIG. 8 shows one embodiment of a receiver according to the invention.

FIG. 9 shows the variations in weight of a branch to which a given content belongs as a function of the time for which that content is consulted by the user.

FIG. 10 shows the incrementing of the weight associated with the content in question following pressing of the “Right” button.

FIG. 11 shows the incrementing of the weight associated with the content in question after operation of the “Store” or “More Information” button.

### DETAILED DESCRIPTION OF THE PREFERRED EMBODIMENTS

First of all, on the subject of the user profile stored in the receiver, the receiver may initially contain a standard user profile from which content is initially selected and offered to the local user.

For example, some user profiles can be oriented toward sports or economics news, without specifying selection criteria relating to finer levels of detail within these two fields.

In one particular embodiment, the standard user profile is loaded into the receiver by means of a removable device such as a magnetic strip card, a smart card, or any similar permanent storage means.

A removable device of the above kind used to load the standard user profile can contain the following types of data:

right to access the network,

right to access the broadcast source,

right to permanent or temporary archival storage, as a function of the nature of the news items,

information relating to the duration and extent of the above access and local archival storage rights,

encryption/decryption keys for exchanging information with the broadcast source, and

available user profiles in the case of a multiplicity of standard user profiles.

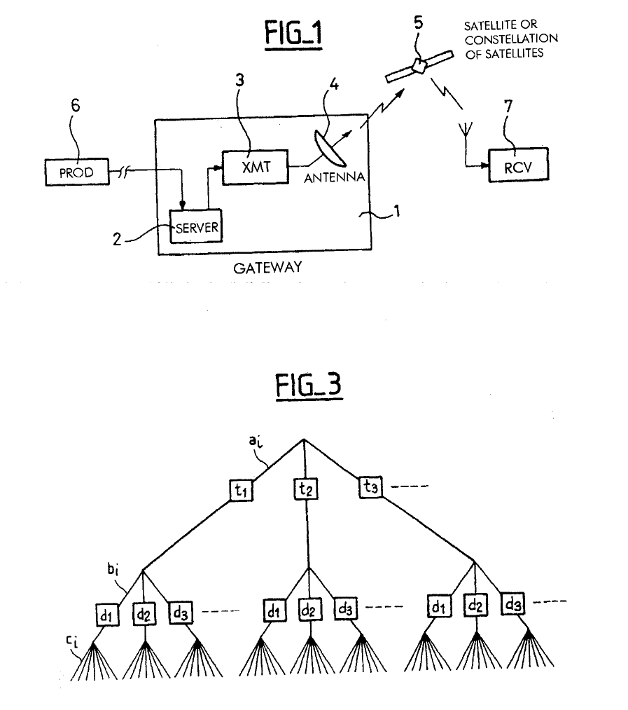

The principle of the method of broadcasting and managing multimedia content disclosed in patent application No. FR 00 06 691, on which the present application is partly based, is summarized hereinafter. The receiver is integrated into a system like that shown in FIG. 1. The system includes a hardware infrastructure consisting of a gateway 1, i.e. a system comprising a broadcast server 2, a transmission system 3, and an antenna 4. The infrastructure also includes a satellite 5 (or a constellation of satellites) adapted to forward signals received from the transmission system to receivers 7 in a given region or over the whole of the planet. There is no limit on the number of receivers 7 in the region covered by the satellite(s). FIG. 1 shows only one receiver 7. Note that the connection between the gateway and the receiver does not have to pass through the satellite(s), and can be provided exclusively by terrestrial relay stations, not shown.

The system processes news content in the following manner.

Initially, the content is produced by a production unit 6.

For easier understanding, the remainder of the description is based on content constituting radio programs, hereinafter referred to as “transmissions”.

The transmissions are classified by the production unit and are then stored in the broadcast server 2, which transmits them to the satellite(s) 5 at the times of best availability of the network.

Obviously there are periods of lower use of the network, in particular between 0 h and 8 h.

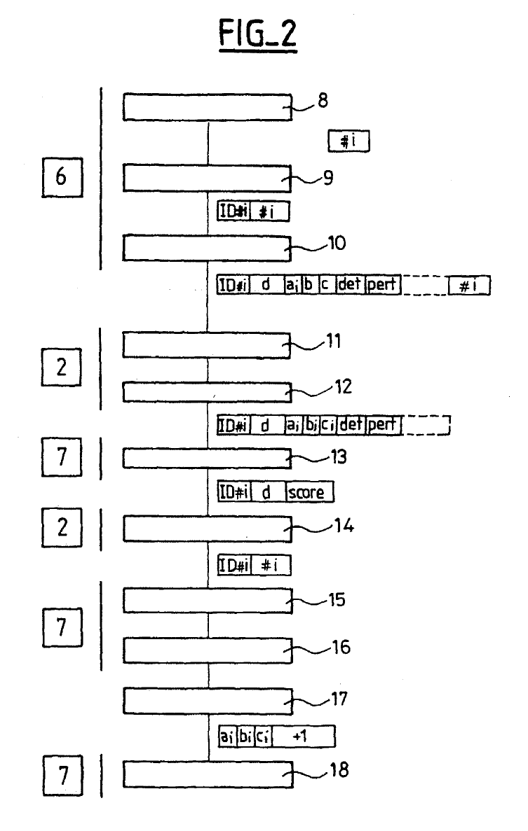

FIG. 2, in which each block 8 to 18 corresponds to one of the following steps, shows the processing of the content in more detail.

Steps 8, 9: The production unit broadcasts the transmissions [#i] to which identifiers [ID#i] are assigned. Each transmission or content is segmented into a number of blocks for adaptation to the transport layer.

Step 10: A transmission descriptor vector is generated for each transmission.

The description vector includes parameters that are used to optimize the use of the transmission resources of the system and to filter the most pertinent content in the receiver.

This vector includes:

the identifier of the content (the transmission) [ID#i],

the duration [d] of the transmission (for audio and video content), and

an indication of the classification of the transmission [aᵢ, bᵢ, cᵢ]; the classification tree can use the Dewey Decimal Classification (DDC), for example, as used by the American Library of Congress, and covering all fields of knowledge; there is of course provision for other models that are more appropriate to identifying multimedia content,

the level of detail [det] representative of processing of the news,

a pertinence mark [pert] for the classification of the transmission,

the size of the expected audience: geographical area, multicast group, etc.,

the priority associated with the content: urgent, at a guaranteed time, as soon as possible, etc.,

content delivery quality: very important, important, best normal, best effort,

the size of the content,

the content type and encoding type (standards such as Windows™, Real Time™ players): speech, audio, text, data, low resolution video, high resolution video,

the language (the S-DMB system covers the whole of Europe),

the encryption type: unencrypted or encrypted content,

the tolerance threshold: percentage of errors tolerated for acceptable operation,

the content expiry date,

an indication of intellectual property or copyright rights,

the ownership/source of the content, etc.

Finally, the program element [#i] as such is generated.

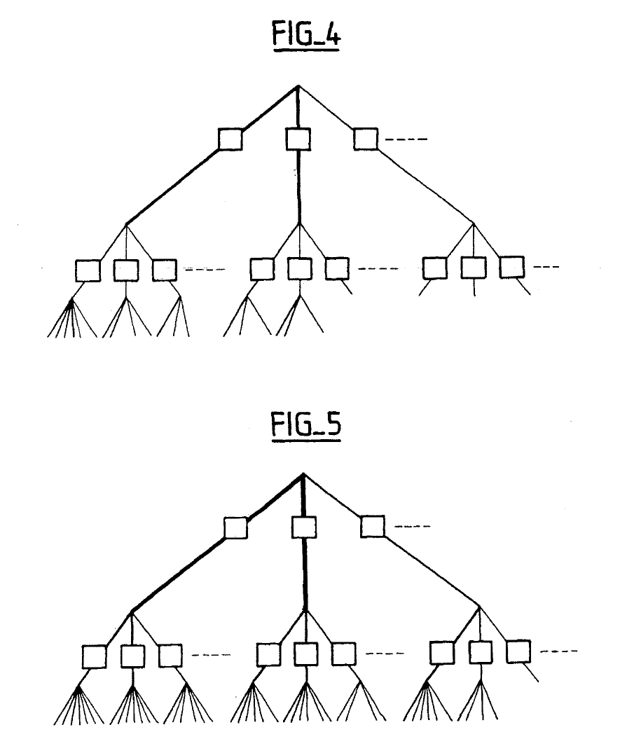

In the present example, classifying the transmission entails positioning it in a tree structure like that shown in FIGS. 3, 4 and 5.

The classification structure used in this example comprises three tree levels.

At the root level, the tree unites all types of programs likely to constitute radio transmissions.

FIG. 3 shows three branches corresponding to this first tree level. Each branch t₁, t₂, t₃ corresponds to a particular type of program, for example: news transmissions, cultural transmissions, music programming.

At the second tree level, each program type t₁, t₂, t₃ is divided into domains, of which three domains d₁, d₂, d₃ are shown here.

Three domains may be considered within the news transmission program type, for example: political news, sports news, cultural news.

Each news domain is in turn divided into sectors, which constitute a third tree level.

As shown in FIG. 2, the classification of a transmission by its position within the classification structure is in this instance expressed by a pointer consisting of three references aᵢ, bᵢ, cᵢ, each of which corresponds to a tree level.

Consider the following detailed example: a national news item relating to the environment can be represented by the vector (2,5,4,9), in which the member 2 represents the news class (or category), the member 5 represents politics, being the rank of politics in the first level branches, the member 4 represents the rank of national political news in the second level branches, and the member 9 represents the rank of national political news relating to the environment in the third level branches. Of course, for conciseness, only the coordinates in the tree are indicated in the description vector. As already stated, the description vector includes other information.

Clearly a news content can be classified under other headings and can therefore be assigned another vector, for example (2,6,2). The classification within the structure is associated with the level of detail indication representative of the degree of detail with which the news content is processed, for example from 1 for a summary to 3 for a very detailed analysis, and the pertinence mark, qualifying the interest accorded to the content concerned within the class concerned. As explained below, this pertinence mark, which is supplied by the production unit (typically by a journalist), can have a value from 0.1 to 10. This mark quantifies the interest that the news content broadcaster deems to apply to the population interested in the branch concerned. Thus the pertinence mark for the same news content assigned more than one vector can be different from one vector to another.

Step 11: All the programs stored in this way and their description vectors are stored in the gateway 1 for broadcasting via the satellite(s) 5.

Step 12: Only the description vectors defined above are broadcast. They specify the characteristics of the content to be broadcast.

Step 13: Each receiver or user terminal receives the description vectors and extracts statistical data representative of the number of times and for how long the user has already accessed the class concerned. For this it uses the pointer [aᵢ, bᵢ, cᵢ] supplied by the description vector to access the statistical table constructed by the receiver. This table may not show the three levels for the branch concerned, especially for branches that are little used by the user or in the early stages of the learning process, during initial use of the device by the user; the evaluation is then based on the lower level access statistics [aᵢ, bᵢ], or even [aᵢ], weighted by the tree level difference.

This results in an evaluation of the content, consisting of a plurality of statistical values in the case of a multiple description vector (where several classes are relevant); in this case, the statistical value retained is the highest value, after weighting by the pertinence mark. The resulting weighted statistical value is referred to as the score of the content.

Each score represents the interest that the user might show in the transmission conveying the content concerned, based on his user profile.

Consequently, the process of evaluating a content entails taking account of the weight of the content, as a function of the branch to which the content belongs (which is identified in the description vector), which weight can be supplied by a table listing the correspondences between weights and addresses of the content in the tree, and the pertinence factor or mark of the content specified in the description vector (between 0.1 and 10, with 1 as the standard value). The score is obtained from the following formula, in which w_{i.j.k} represents the weight of the content:

content pertinence score=w_{i.j.k}.content pertinence.

The filtering of contents as a function of their respective scores is described in detail later.

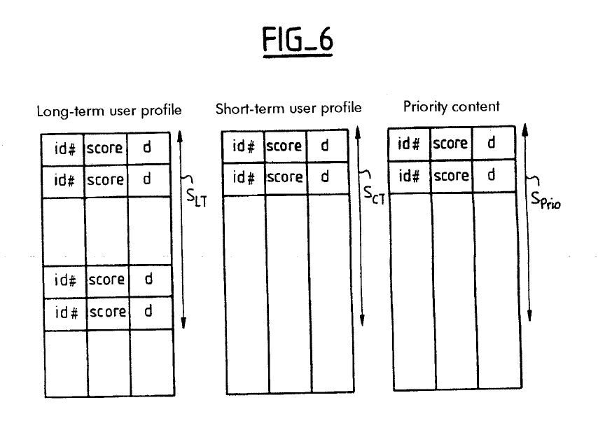

The description vectors are then sorted in decreasing score order, as shown in FIG. 6.

A threshold S_{LT}, S_{CT} and Sₚᵣᵢₒ is determined in the receiver, expressing the storage capacity reserved in the receiver for the transmissions received and relating to each of the “Long-Term User Profile”, “Short-Term User Profile” and “Priority Content” lists.

In FIG. 6, the durations of the various transmissions sorted in decreasing score order are summed for each table.

Selecting transmissions consists of retaining, in decreasing score order, those for which the sum of the durations can be accommodated by the available storage capacity, as defined by the threshold S.

Once the list L of transmissions to be retained has been established, the receiver is ready to receive the transmissions.

The subsequent reception of description vectors, associated for example with recent news contents (latest news), is taken into account by the same process, any contents already stored being overwritten by contents having a higher score.

Step 14: The transmissions are broadcast globally to all receivers. Each of the transmissions produced by the production units is broadcast by the satellite(s) 5 throughout the coverage area.

Step 15: Each receiver stores locally the transmissions whose description vectors it has previously selected.

Step 16: When all the transmissions have been broadcast, each receiver contains a customized program determined by its user profile. To ensure some consistency in the presentation of the contents to the user, the transmissions are sequenced for the consultation phase as a function of criteria that can be defined by the production units or by the user as a function of his preferences: simply by domain and by decreasing score within the domain concerned.

Step 17: The user can then consult the transmissions stored locally in the receiver. Each transmission is presented to the user via a suitable interface described hereinafter, enabling the user to move from one transmission to another and to select a required transmission for execution.

Consequently, in the spirit of the foregoing disclosure, the higher the pertinence score associated with a received content, the greater the benefit of saving that content in the cache memory of the receiver. On the other hand, a content with a low score is more readily deleted because the chance of it interesting the user is low.

It is therefore clear that management of contents within the receiver relies on the profile of the user of the receiver.

The user profile, a concept already employed in the earlier application No. FR 00 06 691 mentioned above, can be a cyclic Generic User Profile (GUP).

This kind of user profile is managed cyclically, typically with a cycle of 24 hours.

From cycle to cycle, a long-term user profile is deduced directly from the GUP using an integration process: if wG_{i.j.k} denotes the weight of the branch i.j.k, then [symbol] wG_{i.j.k} represents the variation of wG_{i.j.k} during the cycle concerned; the variation can be positive or negative according to how the interests of the user in contents belonging to that branch changes, vis à vis other branches:

[symbol]

wG_{i.j.k}=wG_{i.j.k}−wG_{i.j.k}⁻¹,

where wG_{i.j.k}⁻¹ represents the value of wG_{i.j.k} at the end of the preceding cycle.

At the end of the current cycle, the weight w_{i.j.k} of the branch i.j.k for the long-term user profile is deduced from the weight of that branch in the preceding cycle w_{i.j.k}⁻¹ using the following formula:

wL_{i.j.k}=wL_{i.j.k}⁻¹+α· [symbol] wG_{i.j.k}

where α is a constant less than 1 which establishes a very slow progression of the long-term user profile, much slower than the variation of the generic user profile (GUP). In abbreviated form, and introducing the long-term user profile (LTUP), the above equation yields:

LTUP=LTUP⁻¹+α· [symbol] GUP.

Thus the long-term user profile follows exactly the same variations as the generic user profile, from cycle to cycle, but more slowly: the increment (or decrement) applied branch by branch is a reduced value of the increment (or decrement) characterizing the variation of the generic user profile.

The short-term user profile (STUP) is deduced from the generic user profile and the long-term user profile using the following formula, in which pos( )=the value of the argument if the argument is positive, otherwise 0:

STUP=pos(GUP−LTUP).

Consequently, if, at the end of the preceding cycle, the current interest for the branch concerned is lower than the average interest, as established from the long-term user profile, the branch has a null weight, i.e. no content for this branch is stored in the cache memory of the receiver in the short term.

In the contrary situation, the greater the difference between the current interest and the average interest for contents belonging to the branch concerned, the larger the portion of the cache memory allocated to that branch.

This mechanism handles localized interests and tracks user changes perfectly.

The long-term and short-term user profiles are used in the following way:

the memory capacity available for the cache memory is divided into three parts, not necessarily of equal size:

a part associated with the long-term user profile

a part associated with the short-term user profile, and

a part for storing priority content (see below).

The part of the cache memory assigned to each branch of the tree is deduced from the relative weight of the branch, using the following formula:

C_{i.j.k}=(w_{i.j.k}/Σw_{i.j.k})·Cₜₒₜₐₗ

Thus the capacity of the branch i.j.k is calculated from the total available capacity in proportion to the weight of that branch relative to the sum of all weights.

This formula is applied in exactly the same way to the long-term cache memory and to the short-term cache memory; the higher the weight of the branch, the larger the portion of the cache memory used for the branch.

Complementing this, unused cache capacity is recovered to store the remaining contents, classified in decreasing score order.

Consider again now the management of priority contents, solving one of the major problems addressed by this application, as mentioned above.

As already stated, the third cache partition is reserved for priority contents, which differ from other contents because an indicator (flag) in the descriptor shows that the content has priority; the indicator is entered manually, in order to distinguish the most important contents. Priority contents are those featuring scoops, for example, or exclusive or very important news, and the like.

The filtering of the contents has already been explained. It is based on the score of each content received being equal to the product of the weight w_{i.j.k} of the branch to which the content belongs and the pertinence of the content as estimated by the content provider. The pertinence can vary from 0.1 to 10, relative to a standard value of 1, and marginal news tends toward the lower limit of 0.1 whereas a scoop tends toward the value 10.

A list in decreasing score order is drawn up separately for the following three situations, as shown in FIG. 6: on the basis of the long-term user profile, on the basis of the short-term user profile, and, in the case of priority user profiles, simply by using a list in decreasing pertinence order (the user profile having no role in the classification of priority contents).

Once the three lists in decreasing score order have been drawn up, each list is scanned and the following test is applied content by content:

if the remaining space in the part of the cache assigned to the branch can store the content (the storage capacity needed is indicated in the descriptor), the content is retained for storage in the remaining capacity available for the branch concerned,

if the content exceeds the remaining capacity but the score of the content concerned exceeds the scores of contents already stored in the same branch, so that the cumulative capacities used to store the contents and the remaining capacity of the branch concerned exceeds the capacity needed to store the new item, the content is retained for substitution for the contents included in that cumulative capacity, and

if the content does not satisfy either of the above criteria, the content item is not retained.

At the end of this phase three lists are available, specifying the identification number ID# of each of the contents retained. A final pass is effected to assign the remaining capacity to the remaining contents, still in decreasing score order, and separately for the three partitions (long-term, short-term, priority). Selection redundancies between the long-term partition and the short-term partition are eliminated by eliminating the item having the lowest score.

Then, when broadcasting takes place, the terminal analyzes content by content whether the identification number in the header is in one of the three lists; if it is, the content is stored in the cache.

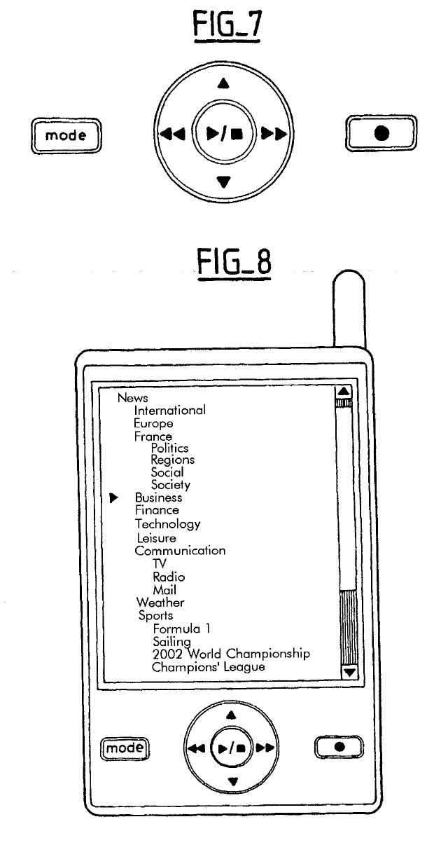

FIG. 7 shows the user interface 20 of a receiver 21, one embodiment of which is shown in FIG. 8. The receiver 21 can be a UMTS terminal, an electronic book (ebook), or a personal digital assistant (PDA).

In automatic access mode, i.e. after pressing the Play key, the contents stored in cache memory are presented spontaneously with the three partitions (long-term, short-term, priority) alternating in proportion to the capacity assigned to them, and scanning the items belonging to the same branch in the three partitions to prevent mixing of the various topics during playback.

FIGS. 7 and 8 show the following features of the user interface:

four cursor control keys: “Up” 22, “Down” 23, “Right” 24, “Left” 25,

a validation key 26, usually situated in the middle of the cursor control keys,

two ancillary keys, here used as a “Mode” key 27 and a “Store” key 28.

Access is initiated by the validation key, like an execute or “Play” key.

The next content is selected by pressing the “Right” key; this is equivalent to the “Next” command in the earlier patent application mentioned above. Pressing this key reduces or increases the weight of the branch to which the content consulted belongs, according to the time at which it is pressed, as described in more detail hereinafter.

The previous item is selected by pressing the “Left” key, which has no impact on the user profile.

The “Up” and “Down” keys enable the user to scroll through the displayed content, without impacting on the user profile.

The “Store” key causes archival storage of the content concerned if the rights of the user allow this. This increases the weight of the branch to which the content belongs.

Pressing the validation key during consultation moves to the next higher level of detail for the same content. If the content is available with the required level of detail in the cache memory, it is presented immediately, and if not a request is sent to the broadcast server in order to recover the content and present it. Note that recovery of missing blocks in the content transmitted is the subject matter of patent application No. FR 02 04 426 filed on May 27, 2002, to which reference may be had for a description of the various types of missing block recovery.

If the validation key is pressed during presentation, the weight of the branch to which the content belongs is increased.

Pressing the “Mode” key toggles between the automatic consultation mode and the manual consultation mode.

In manual mode, the classification tree of the available contents is shown to the user, together with a list of accessible contents, branch by branch, as shown in FIG. 8. The “Up” and “Down” keys are used to move from one sub-branch to another within the same branch, the “Left” key goes to the next level up in the tree, and vice versa for the “Right” key.

The other keys function as in the automatic mode, once the validation key has been pressed. The learning process is therefore subject to the same rules as in the automatic access mode.

The algorithm user for learning the long-term user profile, the short-term user profile or the GUP is directly related to the variation of weight applied to the branch to which the consulted content belongs, as a function of the key pressed and the time at which it is pressed.

Time is counted from the start of the presentation of the content to the user, and of course applies to all kinds of content: text, web page, audio, video, etc.

If the content is attached to the source in more than one branch, the weight is varied only for the branch for which the content has been retained, i.e. in most cases the branch for which the content has the highest score. In an advantageous variant, the weight is varied on all of the branches to which the content is attached.

The principle defined hereinafter is based on a statistical observation; this means that the weight variations effected on a reduced batch of contents are not meaningful; on the other hand, if the tendency is for the user systematically to shorten consultation of contents belonging to the same branch, the user's interest in the domain concerned is low and it is therefore appropriate to reduce the cache size assigned to that domain.

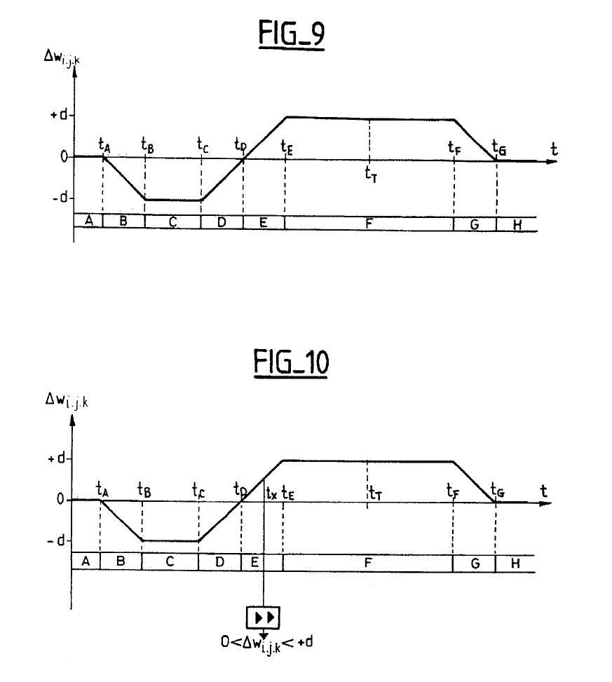

To take the most accurate possible account of the behavior of the user, the weight variation depends on the time at which an action is effected. With regard to the “Right” key (Next), an advantageous solution relies on the principle shown in FIG. 9.

FIG. 9 shows the weight variations of a branch to which a given content belongs according to the time for which the user consults that content.

In this figure, t_{T} represents the average content consultation time; this time is implicit in the case of contents such as audio or video; it is evaluated at source in the case of text or web page contents, as being the time for a standard reader to read the page concerned.

The value d represents a reference increment value which can be constant, depend on the key pressed, calculated in proportion to the cache size occupied by the content consulted (this is the most advantageous solution), calculated in proportion to the average consultation time t_{T}, or depend on the level of detail corresponding to the content consulted; a combination of the above calculation methods can be envisaged.

The increment +d and decrement −d can be assigned different values, for example to make memorizing the user profile faster than forgetting it.

from 0 to t_{A}: Δw_{i.j.k}=0

the delay between the presentation of the content and the reaction of the user is too short for reliably considering the content to be of no interest to the user; the user action is considered to be meaningless; the weight w_{i.j.k} remains unchanged.

from t_{A} to t_{B}: Δw_{i.j.k}<0, decreasing

the delay between the presentation of the content and the reaction of the user is sufficient to deduce that the content is of very little interest to the user; the weight variation Δw_{i.j.k} is negative; it reaches the value −d when t=t_{B}.

from t_{B} to t_{C}: Δw_{i.j.k}=−d, constant negative value

over this range, the actual time at which the key is pressed is not critical; the content consulted can be considered, with a high probability, to be of less interest to the user than the other contents; the weight variation Δw_{i.j.k} is negative, constant and equal to −d.

from t_{C} to t_{D}: Δw_{i.j.k}>0, increasing

pressing the key becomes less and less meaningful with regard to the interest of the user in the content presented; the weight variation [symbol] w_{i.j.k} is negative, but increasing; it reaches 0 at t=t_{D}, signifying that at that time it is not possible to deduce from the user's action whether the content presented is of interest or not; thus the weight is not varied for the branch i.j.k to which the content is attached.

from t_{D} to t_{E}: Δw_{i.j.k}>=0, increasing

statistically speaking, it is increasingly certain that the content is of interest to the user; the variation Δw_{i.j.k} is positive and increasing; it reaches +d at t=t_{E}.

from t_{E} to t_{F}: Δw_{i.j.k}=+d, constant positive value

beyond the point to which t_{E} corresponds, the interest of the user is guaranteed a priori, the consultation time being close to (less than or greater than) the standard average time t_{T}; the variation Δw_{i.j.k} is constant and equal to +d.

from t_{F} to t_{G}: Δw_{i.j.k}>0, decreasing

the behavior of the user is becoming more and more ambiguous, the consultation time significantly exceeding the average time t_{T}; the user's attention has typically been distracted from the content being accessed, and there is less and less reason for the learning process to take account of this access; the variation Δw_{i,j,k} becomes lower and lower, and reaches 0 at t=t_{G}.

beyond t_{G}: Δw_{i.j.k}=0, constant

the access is no longer meaningful in terms of behavior analysis; the user has probably turned away from the receiver; it is not possible to conclude whether the last content consulted is of interest to the user or not.

FIG. 10 shows the incrementing of the weight associated with the content in question after pressing the “Right” button: the “Next” key is pressed between t_{D} and t_{E}, the increment Δw_{i.j.k} is positive, and between 0 and +d.

Moreover, a valid criticism of this principle of calculating Δw_{i.j.k} relates to the wide variation in user behavior, in particular in terms of reading time. For this reason, a correction is advantageously considered, as described below. The correction can be applied uniformly to all of the contents accessed, at the end of the consultation cycle, or to each information domain (identified by the first tree level(s), i or i.j), some domains possibly requiring a longer access time as a function of the aptitude of the user to absorb information in that domain.

In an advantageous variant, the values t_{T} (and consequently the associated values tᵢ) are corrected self-adaptively as a function of the actual behavior of the user during the consultation cycle: the values t_{X} are memorized for each content during the access cycle; they are normalized by the ratio between their average value t_{X avg} and the average of the reference values, t_{T avg}:

t_{X corrected}=(t_{T avg}/t_{X avg})·t_{X}.

The value t_{X} represents the time the key is pressed, starting from the beginning of the presentation of the item to the user, and the values t_{X corrected} are used instead of the values t_{X} to obtain weight variations Δw_{i.j.k}.

The principle just defined relates to the impact of pressing the “Right” (Next) key.

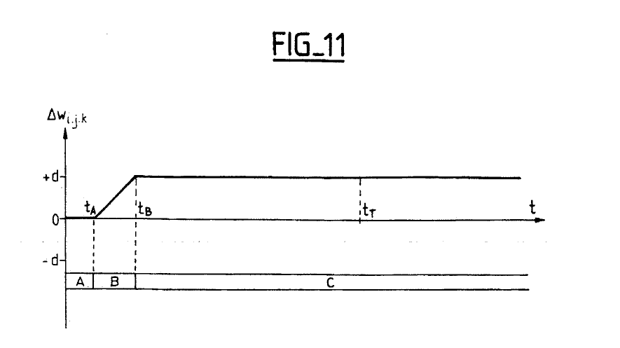

A simpler principle is defined for the “Store” key for storing contents and the “More Detail” key (the central key, i.e. the validation key, pressed during consultation), as shown in FIG. 11:

from 0 to t_{A}: Δw_{i.j.k}=0

the delay between the presentation of the content and the reaction of the user is too short to consider the user's behavior meaningful, the consultation time being very much less than the typical value t_{T}; the weight w_{i.j.k} is not changed

from t_{A} to t_{B}: Δw_{i.j.k}>0, increasing

the delay between the presentation of the content and the reaction of the user is sufficient to deduce therefrom that the content is of interest to the user; the weight variation Δw_{i.j.k} is positive; it reaches the value +d when t=t_{B}.

beyond t_{B}: Δw_{i.j.k}=+d, constant positive value

from t_{B}, it is certain that the user has actually taken note of the content and has acted intentionally, choosing either archival storage of the content or access to a more detailed level of presentation of the subject matter, according to which key is pressed; beyond t_{B}, the time the key is pressed is no longer important, the user having had sufficient time to take note of the subject matter concerned; in an advantageous embodiment, the increment +d is increased if the content called up by the user is not in the local cache, emphasizing, if this situation occurs for the user (particular logo, visual indicator), that the user has launched the content request to a remote server where this kind of request takes much longer than access to contents in the local cache.

What is of concern here is accelerating the learning process in the early stages of use.

In an advantageous embodiment, the user profile is normalized to introduce a learning acceleration mechanism in the early stages of use.

For this, the sum of the branches of the user profile chosen by the broadcaster and used to initialize the user profile on the very first access is set to a low value, for example 4000. According to the earlier patent application mentioned above, the weight of the lower branches is at most equal to the weight of these upper branches.

At the end of each access cycle, typically every 24 hours, the value Σw_{i.j.k} is recalculated, representing the sum of the weights of all the branches of the tree;

if Σ w_{i.j.k}<4000, all the weights of the branches are normalized and thus Σw_{i.j.k}=4000;

if Σ w_{i.j.k} is between 4000 and a ceiling value, typically 32000, the weights are left unchanged;

if Σ w_{i.j.k} exceeds 32000, all the weights of the branches are normalized and thus Σ w_{i.j.k}=32000.

For a constant increment d (or an increment evaluated in accordance with a principle that is invariant during use), this process accelerates learning in the early stages of use; for the branch to which the variation applies, the impact of a variation d is eight times greater when ρ w_{i.j.k}=4000 than when Σ w_{i.j.k}=32000.

The values 4000 and 32000 are given by way of example. The final value is necessarily higher than the original value.

Remember that the cache partition assigned to a branch i.j.k is calculated in proportion to the total cache capacity reserved for the application, using the factor w_{i,j,k}/Δw_{i,j,k}.

In an alternative that can be envisaged, the same behavior is obtained with no normalization process, but by instead weighting the increment d, which is digressive during use, to reduce the impact of pressing any particular key when the learning process is sufficiently far advanced.

Another advantage of the solution described, effected by normalizing Σ w_{i.j.k}, relates to the aggregation of user profiles: such aggregation, effected to optimize the broadcast process by exploiting user profiles, returned to the broadcast server via a secure and anonymous channel, is effected simply by summing the user profiles of each user constituting the audience of the broadcast system for the broadcast channel concerned. With normalized user profiles, in the present example, the contribution of the user profile of a new subscriber has an impact on the global user profile that is eight times weaker.

In the case of the second solution, operating through decreasing weighting of the increment d during learning, it is necessary to send an indication of the seniority of the user or of how far he has advanced in the learning process, based on the number of hours of use, for example. This is much less accurate and simple.

The embodiments described above are in no way limiting on the invention.

They are provided to explain the invention, the scope of the invention being defined by the appended claims.

In particular, the receiver of the invention can be a computer, portable or otherwise, connected to the Internet (World Wide Web).

Note that the description vector is sent over a channel that is very highly protected to offer the greatest guarantee of routing to users.

The pertinence can vary within a range different from that defined here, with a different value for the standard contents.

1. A method of self-adaptive management of the pertinence of multimedia contents for use in a multimedia content receiver in a telecommunication network, when each content is classified in accordance with a tree of categories ranging from the general to the specific, which method takes account of a long-term user profile corresponding to a set of permanent interests of the user of the receiver and a short-term user profile corresponding to a set of temporary interests of the user.

2. The method claimed in claim 1, which includes assigning priority to taking account of a received content referred to as a priority content to which a priority identification flag is appended.

3. The method claimed in claim 1 wherein a generic user profile is previously defined for a user of said receiver and said long-term user profile is deduced from said generic user profile so as to be subject to the same variations as said generic user profile, the trend being formulated over a period much longer than that of the cycle of said generic user profile.

4. The method claimed in claim 1 wherein each content is classified in accordance with a category tree from the general to the specific by means of a pointer identifying the branch i.j.k to which the content belongs, each branch being assigned a weight wG_{i,j,k} representing the degree of interest of the user in said branch, the weight variation [symbol] wG_{i.j.k being defined by the equation:} [symbol]
wG_{i,j,k}=wG_{i.j.k}−wG_{i.j.k}⁻¹,
in which wG_{i,j,k}⁻¹ represents the value of wG_{i,j,k} at the end of the preceding cycle, and the weight w_{i.j,k} of the branch i.j.k for the long-term user profile is deduced from the weight w_{i.j.k}⁻¹ of that branch in the preceding cycle, using the following formula:
wL_{i.j.k}=wL_{i.j.k}⁻¹+α· [symbol] wG_{i,j,k}
where α is a constant much less than 1, for establishing a much slower progression of the weight for the long-term user profile and therefore a variation with the same trend for the long-term user profile relative to that of the generic user profile, in accordance with the following equation, in which LTUP is the long-term user profile:
LTUP=LTUP⁻¹+α· [symbol] GUP.

5. The method claimed in claim 4 wherein said short-term user profile STUP is deduced from the generic user profile and the long-term user profile using the following equation, in which pos( )=the value of the argument if the argument is positive, or 0 otherwise:
STUP=pos(GUP−LTUP).

6. The method claimed in claim 1, wherein the memory capacity available for the cache memory is divided into three memory parts, respectively a part associated with said long-term user profile, a part associated with said short-term user profile, and a part intended for storing priority contents, and the cache memory part C_{i.j.k} assigned to each branch i.j.k of the tree is deduced, for that part, from the relative weight w_{i.j.k} of the branch, using the following equation, in which Cₜₒₜₐₗ represents the total memory capacity for each part:
C_{i,j,k}=(w_{i.j.k}/Σw_{i.j.k})·Cₜₒₜₐₗ.

7. The method claimed in claim 1, wherein a pertinence score is evaluated for each content as a function of an estimated pertinence supplied by the content provider and as a function of said user profile.

8. The method claimed in claim 7, wherein said score of each content received is equal to the product of the weight of the branch to which said content belongs and said pertinence of said content.

9. The method claimed in claim 7, wherein said pertinence varies within a range of values from 0.1 to 10, where the value for a standard content is 1, a content of marginal interest tends toward the lower limit of 0.1, and a content evaluated as being of great interest to users interested in the branch concerned tends toward the value 10.

10. The method claimed in claim 7, wherein a description vector of each content is broadcast to the receiver before broadcasting the associated content and includes a content identifier, the storage capacity needed, and the duration of the content, and respective tables associated with the long-term user profile, the short-term user profile and the priority content are created and then updated and list in detail, in decreasing order, the associated identifier, score, capacity needed and duration.

11. The method claimed in claim 10, wherein, on receiving each content, the presence of said associated identifier in one of said three tables is verified and a positive result leads to storage of said content in said memory part corresponding to said table in which the presence of said identifier has been detected.

12. The method claimed in claim 11, wherein said memory parts respectively associated with said long-term user profile and said short-term user profile are filled in order of decreasing content score until saturation of the respective parts.

13. The method claimed in claim 12, wherein selection redundancies between said long-term memory part and said short-term memory part are eliminated by eliminating contents having the lowest score.

14. The method claimed in claim 1, including learning said generic user profile on initialization of said receiver on the basis of said typical user profile and from the first contents received and the weight variation applied to the branch to which each of said contents belongs, said variation being a function of input of commands to said receiver by said user and the time after which said commands are entered.

15. The method claimed in claim 14, wherein consultation of a given content for a time less than a first value leads to a negative variation of the weight attached to said branch and consultation for a time greater than said first value leads to a positive variation of the weight thereof.

16. The method claimed in claim 15, wherein consultation of the content for a time greater than a second value greater than the first value leads to no modification of the weight of said branch.

17. The method claimed in claim 16, wherein at least the first and second values are corrected self-adaptively as a function of the actual behavior of the user during the consultation cycle.

18. The method claimed in claim 1, wherein archival storage of a content received by said receiver within a time less than a third value leads to no variation of the weight of the branch to which said content belongs and archival storage of said contents after a time greater than said third value leads to a positive variation of that weight.

19. A multimedia content receiver in a telecommunication network which uses the method as claimed in claim 1.
